(19) United States
(12) Patent Application Publication
(10) Pub. No.: US 2026/0336353 A1
(43) Pub. Date: Oct. 29, 2026

(54) Temperature Control Device and Motor Vehicle Comprising Same

(71) Applicant: Bayerische Motoren Werke Aktiengesellschaft, Muenchen (DE)

(72) Inventors: Torsten FRANK, Vatterstetten (DE); Alexander LICHTENBERGER, St. Peter in der Au (AT); Stefan MORGENSTERN, Muenchen (DE); Rene PICHLBAUER, St. Marien (AT); Manuel SCHWARZ, Ingolstadt (DE); Andreas SIUKA, Kematen an der Krems (AT); Ramanan WANNER, Lamerdingen (DE); Ulrich WIRTH, Muenchen (DE)

(21) Appl. No.: 19/486,458

(22) PCT Filed: Jun. 28, 2024
(86) PCT No.: PCT/EP2024/068348

§ 371 Date: Nov. 21, 2025

(30) Foreign Application Priority Data
Jul. 31, 2023 (DE) 10 2023 120 272.3

(51) Int. Cl. B60H 1/00

(52) U.S. Cl. CPC B60H 1/00278; B60H 1/00485; B60H 1/00878; B60H 2001/00928

(57) ABSTRACT

A temperature control device for a motor vehicle has a first operating mode. The motor vehicle includes a temperature control circuit, at least one drive motor, a chiller, a traction battery, and a temperature control circuit cooler which is flowed through by the temperature control circuit and, in a manner separated fluidically therefrom, by air. In the first operating mode the temperature control circuit cooler, the chiller, the traction battery, and the temperature control circuit cooler are flowed through in series in a ring manner in this order.

### BACKGROUND AND SUMMARY

The disclosure relates to a temperature control device for heating and/or cooling different vehicle components of an electrified motor vehicle. Moreover, the disclosure relates to a motor vehicle with a temperature control device of this type.

DE 10 2021 123 953 A1 has disclosed a temperature control circuit which interacts with a refrigerant circuit. If the traction battery is intended to be cooled in this system, it is not possible to do this exclusively with cold coolant coming from the temperature control main circuit, because this coolant which comes from the temperature control main circuit is mixed, before it reaches the traction battery, with a battery circuit which has already been heated by the traction battery (at a location directly upstream of the inlet of a second heat source). It likewise behaves the same way for the case where the traction battery is intended to be heated with heat from the drive motor. Here too, hot coolant coming from the drive motor would be mixed with coolant which comes from the traction battery and, on account of the fact that it is cooler than the coolant coming from the drive motor, lowers the temperature level of the coolant.

It is therefore an object of the present disclosure to eliminate the abovementioned disadvantages at least partially. This object is achieved by way of a temperature control device and a motor vehicle according to the disclosure. Advantageous developments of the disclosure are the subject matter of the dependent claims.

In accordance with one exemplary embodiment of the disclosure, a temperature control device for a motor vehicle is provided, with a temperature control circuit, in which coolant can be circulated and which has the following: at least one drive motor for driving the motor vehicle; a chiller which can be flowed through by the temperature control circuit and, in a manner separated fluidically therefrom, by a refrigerant circuit; a traction battery, and a temperature control circuit cooler which can be flowed through by the temperature control circuit and, in a manner separated fluidically therefrom, by air, wherein the temperature control device has a first operating mode, in which the temperature control circuit cooler, the chiller, the traction battery and again the temperature control circuit cooler can be flowed through in series in a ring-like manner in this order. This exemplary embodiment has the advantage that, during cooling, a coolant at a lower temperature level arrives at the traction battery because it is possible that the coolant which reaches the traction battery comes directly from the temperature control circuit cooler (in the cooling operation such as, for example, during charging at a standstill), without being mixed with warmer coolant which has immediately beforehand already flowed through the traction battery, as in the prior art.

In accordance with a further exemplary embodiment of the disclosure, in the first operating mode, the temperature control circuit cooler, the at least one drive motor, the chiller, the traction battery and again the temperature control circuit cooler can be flowed through in series in a ring-like manner in this order. This exemplary embodiment has the advantage that, during heating of the traction battery, coolant at a higher temperature level arrives at the traction battery, because it is possible that the coolant which reaches the traction battery comes directly from the drive motor (in the heating operation such as, for example, while driving in winter), without being mixed with colder coolant.

In accordance with a further exemplary embodiment of the disclosure, in the first operating mode, a refrigerant-coolant heat exchanger which acts, in particular, as a condenser is arranged between the traction battery and the temperature control circuit cooler. By means of the refrigerant-coolant heat exchanger, the temperature in the temperature control circuit and therefore the pressure level in the temperature control circuit can be lowered, which can have the advantage of element protection for components in the temperature control circuit. Moreover, the temperature control circuit can be heated via the refrigerant circuit by means of the refrigerant-coolant heat exchanger, which makes the implementation of a heat pump functionality possible.

In accordance with a further exemplary embodiment of the disclosure, the temperature control device has, furthermore, a refrigerant circuit cooler which can be flowed through by the refrigerant circuit and, in a manner separated fluidically therefrom, by air. In particular, the refrigerant circuit cooler is arranged in an air flow path through the temperature control circuit cooler, that is to say, in particular, in front of or behind the temperature control circuit cooler as viewed along a vehicle longitudinal axis. This increases the flexibility of the temperature control device considerably and makes it possible that the temperature control circuit is suited to refrigerant circuits of different refrigerants. For example, as a result of the refrigerant circuit cooler, the temperature control device can also be used with the refrigerant R744 because corresponding cooling is enabled and overheating of the refrigerant circuit is avoided.

In accordance with a further exemplary embodiment of the disclosure, the refrigerant circuit cooler is arranged behind the temperature control circuit cooler as viewed along a vehicle longitudinal axis, that is to say the temperature control circuit cooler is positioned closer to a vehicle front end in comparison with the refrigerant circuit cooler. In particular, the refrigerant circuit cooler is arranged directly behind the temperature control circuit cooler as viewed in the vehicle longitudinal direction. This has the advantage that the usually hotter refrigerant circuit cooler is connected downstream of the temperature control circuit cooler, in relation to the incident flow direction. As a result, the cooling performance at the temperature control circuit cooler can be improved, and the temperature level downstream of the temperature control circuit cooler can be lowered. Moreover, refrigerants such as R744 have very high requirements for the coolant temperature. It is advantageous in this context that the temperature control circuit cooler is arranged upstream of the refrigerant circuit cooler in relation to the airflow because the coolant can be cooled in an improved manner in this way.

In accordance with a further exemplary embodiment of the disclosure, the temperature control device has, furthermore, a switching valve in the form of a 5/4-way valve for switching the temperature control circuit into different operating modes. In this way, various operating modes can be realized by way of a single switching valve.

In accordance with a further exemplary embodiment of the disclosure, the temperature control device has, furthermore, a cooler bypass for bypassing the temperature control circuit cooler, in particular for bypassing exclusively the temperature control circuit cooler. As a result of the cooler bypass, thermal energy can be retained in the temperature control circuit if required.

In accordance with a further exemplary embodiment of the disclosure, in the first operating mode, the temperature control circuit cooler, the chiller, the traction battery, the at least one drive motor and again the temperature control circuit cooler can be flowed through in series in a ring-like manner in this order. This exemplary embodiment also has the advantage that, during cooling, a coolant at a lower temperature level arrives at the traction battery because it is possible that the coolant reaching the traction battery comes directly from the temperature control circuit cooler without being mixed with warmer coolant which has already immediately previously flowed through the traction battery, as in the prior art.

Furthermore, the present disclosure provides a temperature control device for a motor vehicle, with a temperature control circuit, in which coolant can be circulated and which has the following: at least one drive motor for driving the motor vehicle; a chiller which can be flowed through by the temperature control circuit and, in a manner separated fluidically therefrom, by a refrigerant circuit; a traction battery, and a temperature control circuit cooler which can be flowed through by the temperature control circuit and, in a manner separated fluidically therefrom, by air, a refrigerant-coolant heat exchanger which is arranged in the temperature control circuit and can selectively be flowed through or bypassed, and a refrigerant circuit cooler which can be flowed through by the refrigerant circuit and, in a manner separated fluidically therefrom, by air. In particular, the refrigerant-coolant heat exchanger acts here as a condenser. This increases the flexibility of the temperature control device considerably and makes it possible that the temperature control circuit is compatible with refrigerant circuits of different refrigerants. For example, as a result of the refrigerant cooler, the temperature control device can also be utilized using the refrigerant R744 because corresponding cooling of the refrigerant circuit is enabled and overheating of the refrigerant circuit is avoided. Moreover, the temperature control circuit can be heated via the refrigerant circuit by means of the refrigerant-coolant heat exchanger, which makes the implementation of a heat pump functionality possible.

Moreover, the present disclosure provides a motor vehicle with a temperature control device of this type.

In the following text, one preferred exemplary embodiment of the present disclosure will be described with reference to the appended drawings. In these drawings, the following is depicted:

### BRIEF DESCRIPTION OF THE DRAWINGS

FIG. 1 is a motor vehicle in accordance with an exemplary embodiment of the disclosure;

FIG. 2 is a temperature control device in accordance with an exemplary embodiment of the disclosure;

FIG. 3 is a first operating mode of the temperature control device from FIG. 2;

FIG. 4 is a second operating mode of the temperature control device from FIG. 2;

FIG. 5 is a third operating mode of the temperature control device from FIG. 2;

FIG. 6 is a temperature control device in accordance with an exemplary embodiment of the disclosure;

FIG. 7 is different operating modes of the temperature control device from FIG. 6;

FIG. 8 is a first operating mode of the temperature control device from FIG. 6, and

FIG. 9 is a temperature control device in accordance with an exemplary embodiment of the disclosure.

### DETAILED DESCRIPTION OF THE DRAWINGS

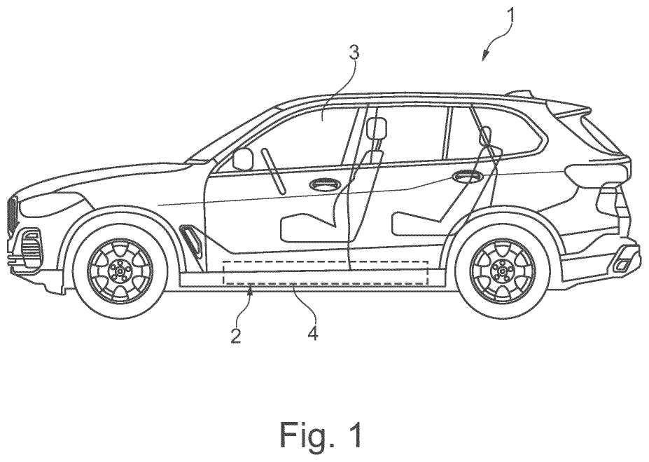

FIG. 1 shows a motor vehicle 1 in accordance with one exemplary embodiment of the disclosure. The motor vehicle 1 has a traction battery 2, in which electrical energy is stored on an electrochemical basis. The motor vehicle 1 is an electrified motor vehicle which is driven purely in a battery-powered manner at least temporarily, such as, for example, a pure electric vehicle or a hybrid vehicle. It is, in particular, a passenger motor vehicle.

The traction battery 2 has a battery housing 4 which is arranged below a vehicle passenger compartment 3 and encloses a multiplicity of battery cells. The battery cells are connected electrically to one another in series and/or in parallel and together configure the traction battery 2 with a voltage level of more than 150 volts. The traction battery 2 stores electrical energy and provides it for the drive of the motor vehicle (that is to say, one or more drive motors) and further vehicle consumers.

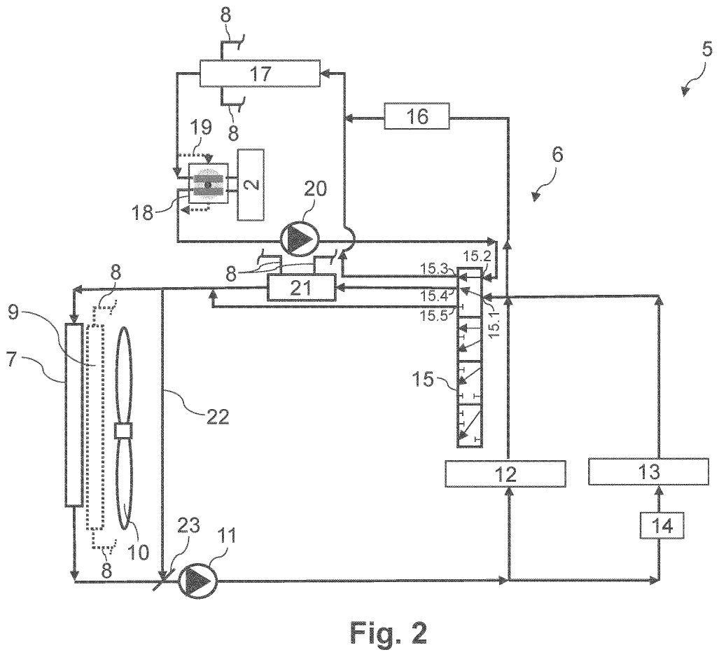

FIG. 2 shows a temperature control device 5 in accordance with a first exemplary embodiment of the disclosure. The temperature control device 5 has a temperature control circuit 6, in which coolant, for example water with additives added, can be circulated. Moreover, the temperature control device 5 has a refrigerant circuit 8 which interacts with the temperature control circuit 6 and in which refrigerant, in particular R744 (CO₂ refrigerant), propane, R1234yf or R134a, can be circulated. Since the focus of this disclosure lies on the temperature control circuit 6 of the temperature control device 5, the refrigerant circuit 8 is merely indicated. The temperature control device 5 is installed in the motor vehicle 1.

The temperature control circuit 6 has a temperature control circuit cooler 7 which can be flowed around or through by the coolant of the temperature control circuit 6 and, in a manner separated fluidically therefrom, by air. Moreover, the temperature control device has a refrigerant circuit cooler 9 which can be flowed around or through by the coolant of the refrigerant circuit 8 and, in a manner separated fluidically therefrom, by air. The refrigerant circuit cooler 9 is arranged behind the temperature control circuit cooler 7 as viewed in the longitudinal direction of the motor vehicle 1. The air is, in particular, ambient air of the motor vehicle 1. In order to assist the air flow around or through the temperature control circuit cooler 7 and/or the refrigerant circuit cooler 9, a fan 10 is provided. A first coolant pump 11 for conveying the coolant in the temperature control circuit 6 is arranged downstream (in relation to a flow direction of the coolant) of the temperature control circuit cooler 7.

At least one drive motor 12, 13 is incorporated downstream of the coolant pump 11 into the temperature control circuit 6, that is to say is arranged in the temperature control circuit 6 in such a way that thermal energy can be output by the drive motor 12, 13 to the coolant and absorbed by the latter, for example by the coolant flowing through a housing or a heat exchanger of the drive motor 12, 13. In the case of a plurality of drive motors 12, 13, as in the exemplary embodiment shown, they are incorporated parallel to one another into the temperature control circuit 6. In the exemplary embodiment shown, a first drive motor 12 and a second drive motor 13 are provided, of which one is assigned to the front axle and the other is assigned to the rear axle.

A first electronic component 14 is connected upstream of the second drive motor 13, with the result that the first drive motor 12 is strictly speaking parallel to the series circuit comprising the first electronic component 14 and the second drive motor 13. The first electronic component 14 can likewise be connected upstream of the first drive motor 12. The first electronic component 14 can have, for example, one or more components from the following group: a vehicle-internal charging unit, an inverter, a control unit (for example, battery control unit), a computer for autonomous driving or entertainment electronics.

The temperature control circuit 6 branches downstream of the at least one drive motor 12, 13 or the parallel connection of the drive motors 12, 13, wherein one section leads to a first connector 15.1 of a first switching valve 15 and another section leads to an optional second electronic component 16. The second electronic component 16 can likewise have one or more components from the following group: a vehicle-internal charging unit, an inverter, a control unit (for example, battery control unit), a computer for autonomous driving or entertainment electronics.

The first switching valve 15 is a 5/4-way valve, with the first connector 15.1, a second connector 15.2, a third connector 15.3, a fourth connector 15.4 and a fifth connector 15.5. Depending on the switching position of the switching valve 15, the five connectors 15.1to 15.5 are connected to one another differently, wherein intermediate positions are also conceivable.

The third connector 15.3 leads to a chiller 17 or heat exchanger which can be flowed through by the coolant of the temperature control circuit 6 and, in a manner separated fluidically therefrom, by the refrigerant of the refrigerant circuit 8, with the result that an exchange of heat is possible between the coolant and the refrigerant. The chiller 17 can optionally have an electric heater which is integrated into the chiller 17. It is likewise possible that this optional electric heater is connected upstream or downstream of the chiller 17 as a separate component.

A section which comes from the second electronic component 16 opens into a line portion which leads from the third connector 15.3 to the chiller 17.

The traction battery 2 is incorporated downstream of the chiller 17 into the temperature control circuit 6, that is to say is arranged in the temperature control circuit 6 in such a way that thermal energy can be output from the traction battery 2 to the coolant and absorbed by the latter, for example by the coolant flowing through at least one battery cooler which is provided in the traction battery 2. By means of a battery bypass valve 18, the coolant coming from the chiller 17 can be conducted completely or partially via a battery bypass line 19 past the traction battery 2, or can be conducted completely through the traction battery 2. For example, the battery bypass valve 18 can act as a safety valve which, in the case of a leakage of coolant in the traction battery 2, conducts the coolant accordingly via the battery bypass line 19 past the traction battery 2.

A second coolant pump 20 for conveying coolant is provided downstream of the traction battery 2. Downstream of the second coolant pump 20, the temperature control circuit 6 leads to the second connector 15.2 of the first switching valve 15.

From a fourth connector 15.4 of the first switching valve 15, the temperature control circuit 6 leads via a refrigerant-coolant heat exchanger 21 back to the temperature control circuit cooler 7. The refrigerant-coolant heat exchanger 21 can be flowed through by the coolant of the temperature control circuit 6 and, in a manner separated fluidically therefrom, by the refrigerant of the refrigerant circuit 8, with the result that a transfer of heat is possible between the coolant and the refrigerant. In a manner dependent on the refrigerant used, the refrigerant-coolant heat exchanger 21 acts as a condenser and/or as a gas cooler. For example, using the refrigerant R134a and R1234yf, the refrigerant-coolant heat exchanger 21 acts as a condenser. Using the refrigerant R744, depending on the temperature level of the refrigerant, the refrigerant-coolant heat exchanger 21 acts as a condenser (up to approximately 30 °C) or as a gas cooler (above approximately 30 °C).

From a fifth connector 15.5 of the first switching valve 15, the temperature control circuit 6 leads, bypassing the refrigerant-coolant heat exchanger 21, back to the temperature control circuit cooler 7. Here, this bypassing line is free from heat sources or heat sinks. In particular, the liquid-cooled refrigerant-coolant heat exchanger 21 is exclusively bypassed in this way.

Furthermore, a cooler bypass 22 is provided, by way of which the temperature control circuit cooler 7 can be bypassed. In particular, the temperature control circuit cooler 7 is exclusively bypassed in this way. A throughflow of the cooler bypass 22 can be released, partially released or shut off via a shut-off valve 23.

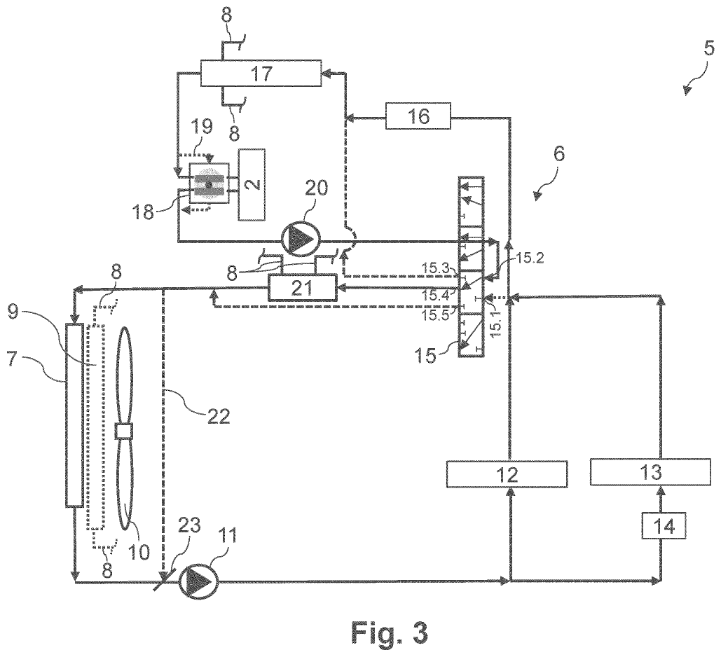

FIG. 3 shows a first operating mode of the temperature control device 6. Here, portions of the temperature control circuit 5 which can be flowed through by coolant are shown using solid lines, and portions which are not flowed through or portions with stationary coolant are shown using dashed lines.

In this operating mode, the first switching valve 15 is switched in such a way that the temperature control circuit cooler 7, the first coolant pump 11, the at least one drive motor 12, 13 with a first electronic component 14 connected upstream, or the parallel connection comprising a first drive motor 12 and a second drive motor 13 with a first electronic component 14 connected upstream, the second electronic component 16, the chiller 17, the traction battery 2, the second coolant pump 20, the refrigerant-coolant heat exchanger 21 and again the temperature control circuit cooler 7 are connected to one another in a closed circuit in series and in this order. In particular, this closed circuit is free from coolant sections which feed in or discharge heat in an active manner.

This first operating mode is suitable, for example, for cooling the traction battery 2 during or after a charging or fast charging procedure when the motor vehicle 1 is at a standstill. In this operating mode, for example, the drive motors 12, 13 are cold or at least colder than the traction battery 2. Here, in the case of a relatively high cooling requirement of the traction battery 2, the circulated coolant is cooled by means of the chiller 17 which is in turn cooled by the refrigerant circuit 8. In the case of a relatively low cooling requirement, cooling of the traction battery 2 only via discharge of heat at the temperature control circuit cooler 7 is also possible.

In this first operating mode, FIG. 3 shows a throughflow of the refrigerant-coolant heat exchanger 21. This is optional, however, and bypassing of the refrigerant-coolant heat exchanger 21 is also possible.

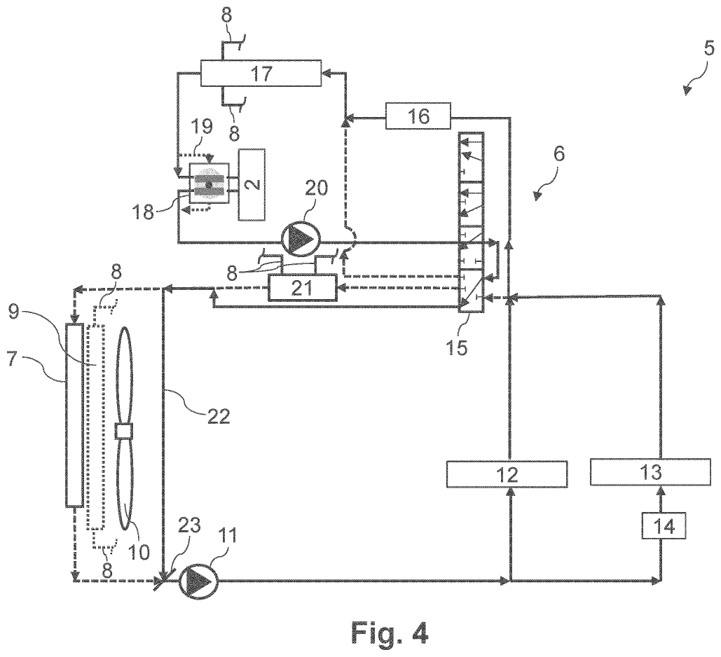

FIG. 4 shows a second operating mode of the temperature control device 6. Here, portions of the temperature control circuit 5 which can be flowed through by coolant are shown using solid lines, and portions which are not flowed through or portions with a stationary coolant are shown using dashed lines.

In this operating mode, the first switching valve 15 is switched in such a way that the first coolant pump 11, the at least one drive motor 12, 13 with a first electronic component 14 connected upstream or the parallel connection comprising a first drive motor 12 and a second drive motor 13 with a first electronic component 14 connected upstream, the second electronic component 16, the chiller 17, the traction battery 2, the second coolant pump 20, the cooler bypass 22 and again the first coolant pump 11 are connected to one another in a closed circuit in series and in this order. In particular, this closed circuit is free from coolant sections which feed in or discharge heat in an active manner.

In this second operating mode, the temperature control circuit cooler 7 is bypassed, as a result of which thermal energy remains in the temperature control circuit 6. As a result, for example, thermal energy of the at least one drive motor 12, 13 can be used to heat the traction battery 2. This makes sense, for example, while driving at cold ambient temperatures (for example, −10 °C).

Moreover, it is possible by way of the described circuit to heat the traction battery 2 via a heat pump functionality. For this purpose, the refrigerant circuit 8 absorbs ambient heat via the refrigerant circuit cooler 9, in order to introduce heat via the refrigerant-coolant heat exchanger 21 into the temperature control circuit 6 via a heat pump functionality.

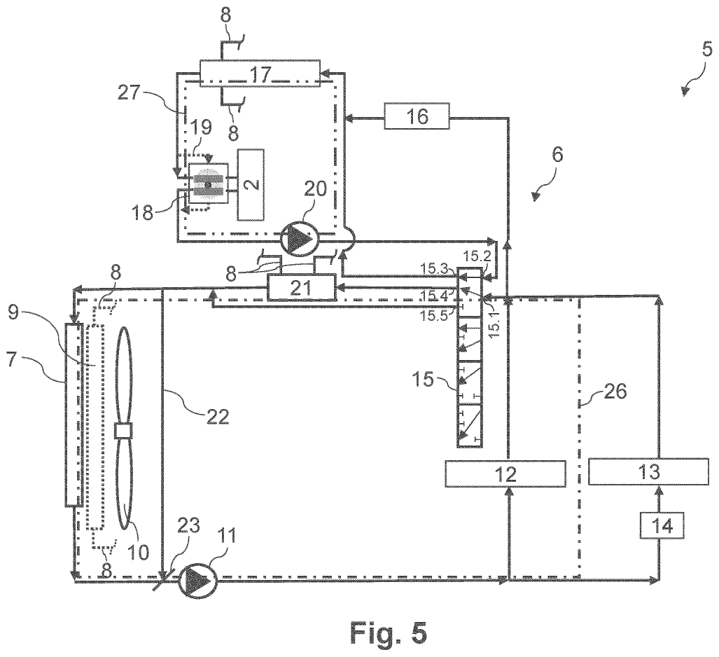

FIG. 5 shows a third operating mode of the temperature control device from FIG. 2, in which the switching valve 15 assumes the switching position shown in FIG. 2. In this switching position, the second connector 15.2 is connected to the third connector 15.3, and the first connector 15.1 is connected to the fourth connector 15.4.

In this way, a motor circuit 26 is formed which is illustrated in FIG. 5 using a dash-dotted line. In this motor circuit 26, the temperature control circuit cooler 7, the first coolant pump 11, the at least one drive motor 12, 13 with a first electronic component 14 connected upstream or the parallel connection comprising a first drive motor 12 and a second drive motor 13 with a first electronic component 14 connected upstream, the refrigerant-coolant heat exchanger 21 and again the temperature control circuit cooler 7 are connected to one another in series and, in particular, in this order, with the result that coolant can be circulated by means of the first coolant pump 11 in a closed circuit.

Moreover, a battery circuit 27 is formed which is illustrated in FIG. 5 using a dash-double dotted line. In this battery circuit 27, the chiller 17, the traction battery 2 and the second coolant pump 20 are connected to one another in a ring-like manner in series, with the result that coolant can be circulated by means of the second coolant pump 20 in a closed circuit. Here, the traction battery might be cooled, for example, by means of the chiller 17.

Here, the motor circuit 26 can be operated selectively and independently of the battery circuit 27, wherein no exchange of coolant takes place between the motor circuit 26 and the battery circuit 27.

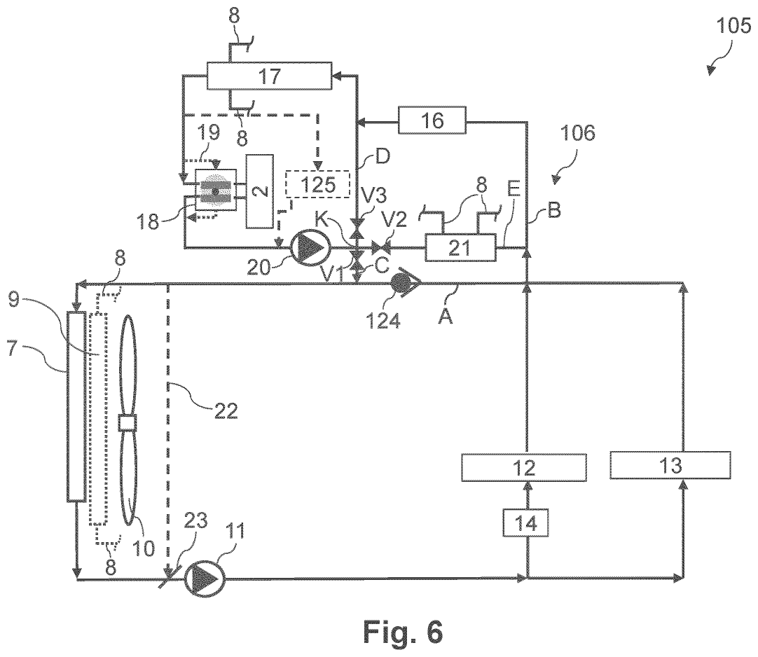

FIG. 6 shows a temperature control device 105 in accordance with a second exemplary embodiment of the disclosure. The temperature control device 105 has a temperature control circuit 106, in which coolant, for example water with additives added, can be circulated. Moreover, the temperature control device 105 has the refrigerant circuit 8 (see description of the first exemplary embodiment) which interacts with the temperature control circuit 106. The temperature control device 105 is installed in the motor vehicle 1. With regard to the components known from the first exemplary embodiment (identical designations), reference is made to the above description thereof which also applies to the second exemplary embodiment.

The temperature control circuit 106 has the temperature control circuit cooler 7, the refrigerant circuit cooler 9, the fan 10, the cooler bypass 22 and the shut-off valve 23. The first coolant pump 11 for conveying the coolant in the temperature control circuit 106 is arranged downstream (in relation to a flow direction of the coolant) of the temperature control circuit cooler 7.

Downstream of the coolant pump 11, the at least one drive motor 12, 13 or the parallel connection, described in the first exemplary embodiment, of drive motors 12, 13 is incorporated into the temperature control circuit 106. The first electronic component 14 is connected upstream of the first drive motor 12, with the result that the second drive motor 13 is parallel to the series connection comprising the first electronic component 14 and the first drive motor 12. The first electronic component 14 can likewise be connected upstream of the second drive motor 13.

The temperature control circuit 106 branches off downstream of the at least one drive motor 12, 13 or the parallel connection of the drive motors 12, 13, wherein a first section A flows via a one-way valve 124 directly back to the cooler bypass 22 or to the temperature control circuit cooler 7. A second section B leads to the optional second electronic component 16.

The switching valve 15 is not provided in the second exemplary embodiment. Instead, the temperature control circuit 106 has a first valve V1, a second valve V2 and a third valve V3. These valves can be shut-off valves which shut off or completely release a throughflow of coolant. They can also have intermediate positions for partially releasing the throughflow, or can be configured as proportional valves.

Moreover, the temperature control circuit 106 has the chiller 17, with an optional, integrated or separate electric heater, the traction battery 2, the battery bypass valve 18 with the battery bypass line 19, and the second coolant pump 20. These components are arranged as in the first exemplary embodiment. A valve manifold point K is provided downstream of the second coolant pump 20.

From the valve manifold point K, a third section C which is provided with the first valve V1 leads into the first section A, to be precise at a location of the first section A between the one-way valve 124 and the cooler bypass 22.

Moreover, a fourth section D which is provided with the third valve V3 leads from the valve manifold point K to the chiller 17. Here, the second section B which has the second electronic component 16 opens into the fourth section D, to be precise at a location upstream of the chiller 17.

It goes without saying that the three valves V1 to V3 and their functions can also be combined in part or completely in one multi-valve.

Furthermore, a fifth section E leads from the valve manifold point K to the second section B at a location between the at least one drive motor 12, 13 and the second electronic component 14. The fifth section E is provided with the refrigerant-coolant heat exchanger 21.

Moreover, a third electronic component 125 can be incorporated into the temperature control circuit 106, from which third electronic component a feed section branches downstream of the chiller 17 and upstream of the traction battery 2, and from which third electronic component a discharge section opens upstream of the second coolant pump 20 (and downstream of the traction battery 2). In this way, the third electronic component 125 can also be incorporated in the temperature control circuit 6 of the first exemplary embodiment.

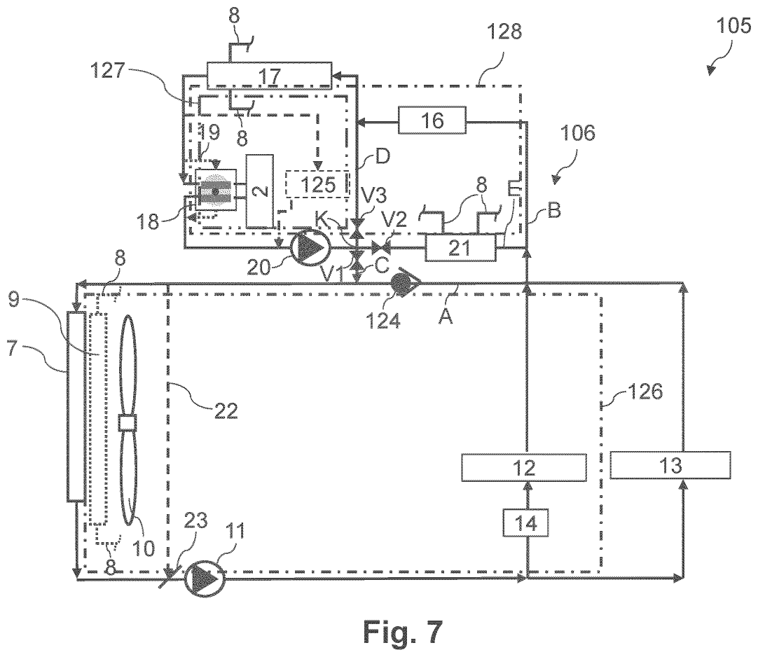

FIG. 7 shows different operating modes of the temperature control device from FIG. 5. If the first valve V1 is closed, a motor circuit 126 is formed which is illustrated in FIG. 7 using a dash-dotted line. In this motor circuit 126, the temperature control circuit cooler 7, the first coolant pump 11, the at least one drive motor 12, 13 with a first electronic component 14 connected upstream or the parallel connection comprising a first drive motor 12 and a second drive motor 13 with a first electronic component 14 connected upstream, the one-way valve 124 and again the temperature control circuit cooler 7 are connected to one another in series and, in particular, in this order, with the result that coolant can be circulated by means of the first coolant pump 11 in a closed circuit.

If, in the case of a closed first valve V1, the second valve V2 is also closed and the third valve V3 is open, a battery circuit 127 is formed which is illustrated in FIG. 7 by way of a dash-double dotted line. In this battery circuit 127, the chiller 17, the traction battery 2 and the second coolant pump 20 are connected to one another in a ring-like manner in series, with the result that coolant can be circulated by means of the second coolant pump 20 in a closed circuit. Here, the traction battery might be cooled, for example, by means of the chiller 17.

If the first valve V1 is closed, the second valve V2 is open and the third valve V3 is closed, a battery-condenser circuit 128 is formed which is illustrated in FIG. 7 by a dash-dotted line. In this battery-condenser circuit 128, the chiller 17, the traction battery 2, the second coolant pump 20, the refrigerant-coolant heat exchanger 21 and the second electronic component 16 are connected to one another in a ring-like manner in series, with the result that coolant can be circulated by means of the second coolant pump 20 in a closed circuit.

Here, the motor circuit 126 can be operated selectively and independently of the battery circuit 127 and the battery-condenser circuit 128, wherein substantially no exchange of coolant takes place between the motor circuit 126 firstly and the battery circuit 127 or the battery-condenser circuit 128 secondly.

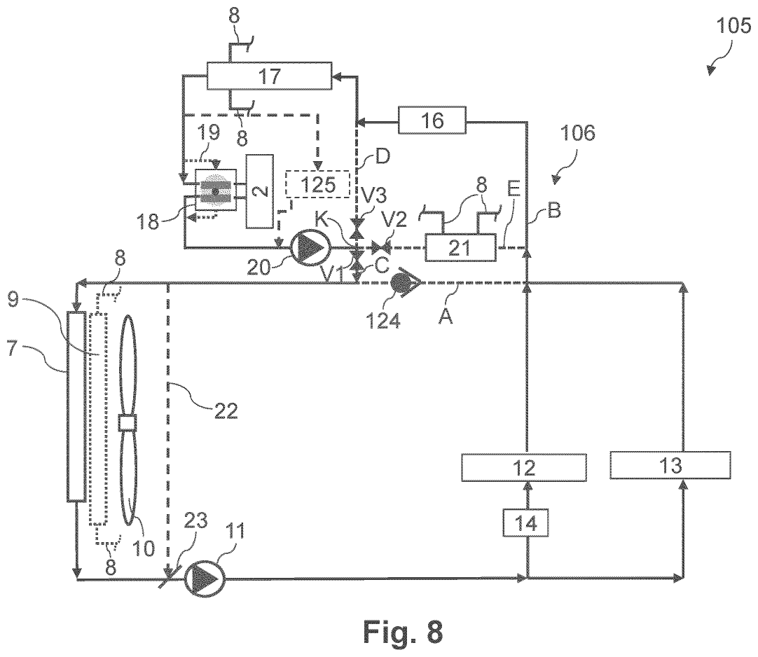

FIG. 8 shows a first operating mode of the temperature control device from FIG. 5. This corresponds substantially to the first operating mode of the first exemplary embodiment, wherein, in contrast thereto, the refrigerant-coolant heat exchanger 21 is bypassed. In FIG. 8, portions of the temperature control circuit 5 which can be flowed through by coolant are shown using solid lines, and portions which are not flowed through or portions with stationary coolant are shown using dashed lines.

In this operating mode, the first valve V1 is open, the second valve V2 is closed and the third valve V3 is closed. In this way, the temperature control circuit cooler 7, the first coolant pump 11, the at least one drive motor 12, 13 with a first electronic component 14 connected upstream or the parallel connection comprising a first drive motor 12 and a second drive motor 13 with a first electronic component 14 connected upstream, the second electronic component 16, the chiller 17, the traction battery 2, the second coolant pump 20 and again the temperature control circuit cooler 7 are connected to one another in a closed circuit in series and in this order. In particular, this closed circuit is free from coolant sections which feed in or discharge heat in an active manner. Little or no flow of coolant prevails through the one-way valve 124, since the suction of the second coolant pump 20 pulls the coolant coming from the at least one drive motor 12, 13 into the second section B.

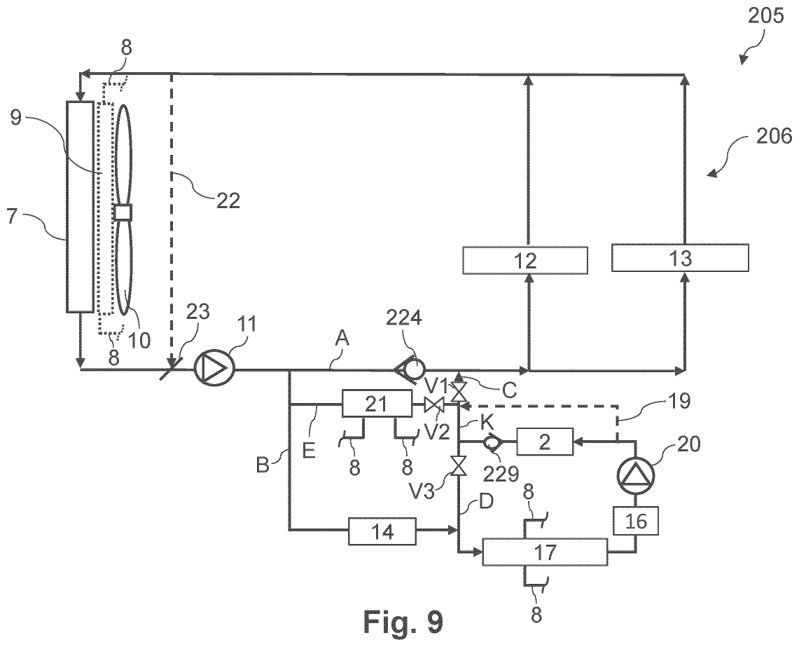

FIG. 9 shows a temperature control device 205 in accordance with a third exemplary embodiment of the disclosure. With regard to the components known from the first exemplary embodiment (identical designations), reference is made to their description above which also applies to the third exemplary embodiment.

The temperature control device 205 has a temperature control circuit 206, in which coolant, for example water with additives added, can be circulated. Moreover, the temperature control device 205 has a refrigerant circuit 8 (see first exemplary embodiment) which interacts with the temperature control circuit 6. The temperature control device 205 is installed in the motor vehicle 1.

The temperature control circuit 206 has the temperature control circuit cooler 7, the refrigerant circuit cooler 9, the fan 10, the cooler bypass 22 and the shut-off valve 23 (see first exemplary embodiment). The first coolant pump 11 is arranged downstream of the temperature control circuit cooler 7 (in relation to a flow direction of the coolant).

The temperature control circuit 206 branches downstream of the first coolant pump 11, wherein a first section A leads via a first one-way valve 224 directly to the at least one drive motor 12, 13 or to the parallel connection of a plurality of drive motors 12, 13. A second section B leads to the first electronic component 14.

Furthermore, the temperature control circuit 206 has the first valve V1, the second valve V2 and the third valve V3 (see second exemplary embodiment).

Moreover, the temperature control circuit 206 has the chiller 17, with an optional integrated or separate electric heater, the second electronic component 16, the second coolant pump 20 and the traction battery 2 which are arranged in this order in series.

A second one-way valve 229 is arranged downstream of the traction battery 2, and the valve manifold point K is arranged downstream thereof. The switchable battery bypass line 19 branches off upstream of the traction battery 2 for selective bypassing of the traction battery 2, and opens directly into the valve manifold point K.

From the valve manifold point K, a third section C which is provided with the first valve V1 leads into the first section A, to be precise at a location of the first section A between the first one-way valve 224 and the at least one drive motor 12, 13.

Moreover, a fourth section D which is provided with the third valve V3 leads from the valve manifold point K to the chiller 17. Here, the second section B which has the first electronic component 14 opens into the fourth section D, to be precise at a location upstream of the chiller 17.

Moreover, a fifth section E leads from the valve manifold point K to the second section B at a location between the first coolant pump 11 and the second electronic component 14. The fifth section E is provided with the refrigerant-coolant heat exchanger 21.

The at least one drive motor 12, 13 or a parallel connection of the first drive motor 12 and the second drive motor 13 is incorporated into the temperature control circuit 6 downstream of the third section C or the first one-way valve 224.

Downstream of the at least one drive motor or the parallel connection of the drive motors 12, 13, the temperature control circuit 206 leads back to the cooler bypass 22 or the temperature control circuit cooler 7.

The temperature control circuit 206 functions in a similar manner to the temperature control circuit 106 (see FIGS. 5 to 7), only with the substantial difference that the second section B does not branch off downstream of the at least one drive motor 12, 13 as in the second exemplary embodiment, but rather branches off downstream of the first coolant pump 11 and upstream of the at least one drive motor 12, 13.

A motor circuit can be produced as in the second exemplary embodiment if the first valve V1 is closed. In this motor circuit, the temperature control circuit cooler 7, the first coolant pump 11, the first one-way valve 224, the at least one drive motor 12, 13 and again the temperature control circuit cooler 7 are connected to one another in series and, in particular, in this order, with the result that coolant can be circulated by means of the first coolant pump 11 in a closed circuit.

If, in the case of a closed first valve V1, the second valve V2 is also closed and the third valve V3 is open, a battery circuit is formed. In this battery circuit, the chiller 17, the second electronic component, the second coolant pump 20, the traction battery 2 and the second one-way valve 229 are connected to one another in a ring-like manner in series, with the result that coolant can be circulated by means of the second coolant pump 20 in a closed circuit. Here, the traction battery might be cooled, for example, by means of the chiller 17.

If the first valve V1 is closed, the second valve V2 is open and the third valve V3 is closed, a battery-condenser circuit is formed. In this battery-condenser circuit, the chiller 17, the second electronic component, the second coolant pump 20, the traction battery 2, the second one-way valve 229, the refrigerant-coolant heat exchanger 21 and the first electronic component 14 are connected to one another in a ring-like manner in series, with the result that coolant can be circulated by means of the second coolant pump 20 in a closed circuit.

Here, as in the second exemplary embodiment, the motor circuit can be operated selectively and independently of the battery circuit and the battery-condenser circuit, wherein substantially no exchange of coolant takes place between the motor circuit firstly and the battery circuit or the battery-condenser circuit secondly.

Furthermore, a first operating mode can be produced, in which the first valve V1 is open, the second valve V2 is closed and the third valve V3 is closed. In this way, the temperature control circuit cooler 7, the first coolant pump 11, the first electronic component 14, the chiller 17, the second electronic component 16, the second coolant pump 20, the traction battery 2, the second one-way valve 229, the at least one drive motor 12, 13 with a first electronic component 14 connected upstream or the parallel connection comprising a first drive motor 12 and a second drive motor 13 with a first electronic component 14 connected upstream, and again the temperature control circuit cooler 7 are connected to one another in a closed circuit in series and in this order. In particular, this closed circuit is free from coolant sections which feed in or discharge heat in an active manner.

While the disclosure has been illustrated and described in detail in the drawings and the preceding description, this illustration and description is to be understood to be by way of example and not restrictive, and the intention is not to restrict the disclosure to the disclosed exemplary embodiment. The mere fact that certain features are mentioned in different dependent claims is not intended to indicate that a combination of these features might not also be used advantageously.

### LIST OF DESIGNATIONS

1 Motor vehicle
2 Traction battery
3 Vehicle passenger compartment
4 Battery housing
5 Temperature control device
6 Temperature control circuit
7 Temperature control circuit cooler
8 Refrigerant circuit
9 Refrigerant circuit cooler
10 Fan
11 First coolant pump
12 First drive motor
13 Second drive motor
14 First electronic component
15 First switching valve
15.1 First connector
15.2 Second connector
15.3 Third connector
15.4 Fourth connector
15.5 Fifth connector
16 Second electronic component
17 Chiller
18 Battery bypass valve
19 Battery bypass line
20 Second coolant pump
21 Refrigerant-coolant heat exchanger
22 Cooler bypass
23 Shut-off valve
26 Motor circuit
27 Battery circuit
105 Temperature control device
106 Temperature control circuit
124 One-way valve
125 Third electronic component
126 Motor circuit
127 Battery circuit
128 Battery-condenser circuit
205 Temperature control device
206 Temperature control circuit
224 First one-way valve
229 Second one-way valve
A First section
B Second section
C Third section
D Fourth section
E Fifth section
K Valve manifold point
V1 First valve
V2 Second valve
V3 Third valve

1-10. (canceled)

11. A temperature control device for a motor vehicle, comprising:
a first operating mode, wherein the motor vehicle includes
a temperature control circuit in which coolant is circulated,
at least one drive motor for driving the motor vehicle,
a chiller which is flowed through by the temperature control circuit and, in a manner separated fluidically therefrom, by a refrigerant circuit,
a traction battery, and
a temperature control circuit cooler which is flowed through by the temperature control circuit and, in a manner separated fluidically therefrom, by air, wherein
in the first operating mode the temperature control circuit cooler, the chiller, the traction battery, and the temperature control circuit cooler are flowed through in series in a ring manner in this order.

12. The temperature control device according to claim 11, wherein, in the first operating mode, the temperature control circuit cooler, the at least one drive motor, the chiller, the traction battery, and again the temperature control circuit cooler is flowed through in series in a ring-like manner in this order.

13. The temperature control device according to claim 11, wherein, in the first operating mode, a refrigerant-coolant heat exchanger is arranged between the traction battery and the temperature control circuit cooler.

14. The temperature control device according to claim 11, having furthermore a refrigerant circuit cooler which is flowed through by the refrigerant circuit and, in a manner separated fluidically therefrom, by air.

15. The temperature control device according to claim 14, wherein the refrigerant circuit cooler is arranged behind the temperature control circuit cooler as viewed along a vehicle longitudinal axis.

16. The temperature control device according to claim 11, furthermore with a switching valve in the form of a 5/4-way valve for switching the temperature control circuit into different operating modes.

17. The temperature control device according to claim 11, furthermore with a cooler bypass for bypassing the temperature control circuit cooler.

18. The temperature control device according to claim 11, wherein, in the first operating mode, the temperature control circuit cooler, the chiller, the traction battery, the at least one drive motor, and again the temperature control circuit cooler is flowed through in series in a ring-like manner in this order.

19. A system comprising:
a motor vehicle; and
a temperature control device configured to cooperate with the motor vehicle, wherein the motor vehicle includes
a temperature control circuit in which coolant is circulated,
at least one drive motor for driving the motor vehicle,
a chiller which is flowed through by the temperature control circuit and, in a manner separated fluidically therefrom, by a refrigerant circuit;
a traction battery,
a temperature control circuit cooler which is flowed through by the temperature control circuit and, in a manner separated fluidically therefrom, by air,
a refrigerant-coolant heat exchanger which is arranged in the temperature control circuit and can selectively be flowed through or bypassed, and
a refrigerant circuit cooler which is flowed through by the refrigerant circuit and, in a manner separated fluidically therefrom, by air.

20. A motor vehicle comprising:
the temperature control device according to claim 11.
